(19) United States
(12) Patent Application Publication
(10) Pub. No.: US 2026/0195673 A1
(43) Pub. Date: Jul. 9, 2026

(54) METHOD AND MODEL FOR ENHANCING ORGANIZATIONAL DEVELOPMENT

(71) Applicants: Daniel Elder, Temple, TX (US); David Litteral, Hillsboro, KY (US); Jeffrey Fite, Belton, TX (US)

(72) Inventors: Daniel Elder, Temple, TX (US); David Litteral, Hillsboro, KY (US); Jeffrey Fite, Belton, TX (US)

(21) Appl. No.: 18/807,141

(22) Filed: Aug. 16, 2024

Related U.S. Application Data
(60) Provisional application No. 63/583,324, filed on Sep. 18, 2023.

(51) Int. Cl. G06Q 10/0631

(52) U.S. Cl. CPC G06Q 10/063118

(57) ABSTRACT

A method for enhancing organizational development by identifying a target population within an organization and establishing a community science team of elite experts with experience in the target population's roles. The team collaborates to develop research products for a study, providing context and translation at all information touchpoints. The study is conducted using the research products to gather data about the target population, employing both qualitative and quantitative data collection methods. The gathered data is then used to inform changes in organizational practices, potentially leading to improved personnel development and overall organizational effectiveness. The method is applicable to various organizational settings, including military, governmental, and civilian industrial/commercial populations.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application is a Utility Patent application claiming priority to U.S. Provisional Patent Application Ser. No. 63/583,324, filed on Sep. 18, 2023, which is incorporated by reference herein in its entirety.

### BACKGROUND OF THE INVENTION

### 1) Field of the Invention

The invention relates, in general, to the field of personnel development studies and more particularly, to a blended approach to close the research-to-practice gap in personnel development studies using a blended community science model.

### 2) Description of Related Art

True organizational change begins at the level of the individual employee. Executives who have a desire to transform their organizations must have buy-in from all levels. Often, the changes are for the benefit of the employees in the form of career development or advancement. It is common to conduct research to examine the need for alterations and determine the most effective way to execute the changes. Research, in and of itself, doesn't change practices. There often exists a gap between researchers and the practitioners at each of the levels being researched. Applied researchers are adequately trained to conduct studies and examine data. However, many times they are ill-prepared to understand the nuances of the industry or organization that they are tasked to investigate. To decrease or eliminate the research-to-practice gap, we have created a novel approach that combines elements of community science and participatory action research. The timely involvement of elite experts provides the researchers with context and translation to help them understand the population being studied. Additionally, the elite experts communicate with the participants, which provides them with a better understanding of the nature of the study. This bi-directional translation is a critical key to decreasing the research-to-practice gap and improving the outcome of the research.

The problem is that in most professions there exists a wide gap between research and practice. This situation is further complicated by employees who lack the desire to participate in studies, regardless of the fact that those studies may improve their career. Additionally, the ethical treatment of people in scientific research places constraints on research wherein participants must be strictly voluntary and often anonymous. Applied researchers must understand the culture of the population they intend to study. The amount of participation in a study can be linked to the researcher's ability to reach the target audience by speaking their language and understanding the feedback from the participants. The greater the participation in the study means that there is greater statistical strength in the analysis of data. The research-to-practice gap currently degrades the scientists'abilities to interpret the data due to the lack of understanding of the context of the participants'responses.

Organizational development is a field that focuses on improving the effectiveness of an organization and its members through the application of behavioral science knowledge. Organizational development encompasses a wide range of activities, including but not limited to strategic planning, team building, leadership development, and change management.

In the context of organizational development, research plays a pivotal role in understanding the dynamics of an organization, identifying areas of improvement, and formulating strategies to address these areas. Various research methodologies are employed in this field, including both qualitative and quantitative approaches. Qualitative research methods, such as interviews and focus groups, are often used to gain insights into the experiences and perspectives of individuals within an organization. On the other hand, quantitative research methods, such as surveys and statistical analyses, are used to gather numerical data and measure variables within an organization.

Community science, also known as citizen science or public participation in scientific research (PPSR), is a research approach that involves the active participation of non-professional scientists or community members in scientific research. This approach is often used in environmental and ecological research, but it has also been applied in other fields, including organizational development. Community science can provide valuable insights and data that may not be accessible through traditional research methods.

Participatory action research (PAR) is another research approach that actively involves the people who are the subject of the research in all stages of the research process, from defining the research question to collecting and analyzing data and implementing the research findings. PAR is often used in social and educational research to gain knowledge and actively influence change. It is based on the principle that those who are affected by the research have the right to participate in the research process.

Elite experts, in the context of research, are individuals who possess a high level of expertise and experience in a particular field or profession. These individuals can provide valuable insights and context that can enhance the quality and relevance of the research. In organizational research, elite experts can include current and former senior executives, managers, and other individuals who have extensive experience and knowledge about the organization and its operations.

In the field of organizational development, research is often conducted to identify gaps in personnel development and to develop strategies to address these gaps. Personnel development refers to the activities and processes that are designed to improve the skills, knowledge, and abilities of employees, and it is a central component of organizational development. Effective personnel development can enhance the performance and productivity of employees, and it can also contribute to the overall success and competitiveness of the organization.

### SUMMARY OF THE INVENTION

One aspect of the present invention is directed to a method for enhancing organizational development includes identifying a target population within an organization, establishing a community science team comprising elite experts who have experience with the target population, collaborating with the community science team to develop research products for a study, providing the community science team with context and translation at all information touch-points, and conducting the study using the research products to gather data about the target population. The method may include the target population within the organization comprising mid-level and senior-level supervisors. The elite experts may have experience in the same professional roles as the target population. The method may further include the step of recruiting and retaining operational unit champions, advocates, and sponsors to reduce the research-practice gap. The research products for the study may be developed through a series of events including workshops, systematic review of evidence-based research, independent study and participatory research, development of relevant research questions, and an After-Action Review. The data about the target population may be gathered using both qualitative and quantitative data collection methods. The community science team may comprise a Principal Investigator, Program Manager, Research Director, and Research/Data Assistant.

Another aspect of the present invention is directed to a method for reducing the research-practice gap in organizational development includes identifying a target population within an organization, establishing a community science team comprising elite experts who have experience with the target population, collaborating with the community science team to develop research products for a study, providing the community science team with context and translation at all information touch-points, conducting the study using the research products to gather data about the target population, and using the data to inform changes in organizational practices. The method may include the target population within the organization comprising mid-level and senior-level supervisors. The elite experts may have experience in the same professional roles as the target population. The method may further include the step of recruiting and retaining operational unit champions, advocates, and sponsors to reduce the research-practice gap. The research products for the study may be developed through a series of events including workshops, systematic review of evidence-based research, independent study and participatory research, development of relevant research questions, and an After-Action Review. The data about the target population may be gathered using both qualitative and quantitative data collection methods. The community science team may comprise a Principal Investigator, Program Manager, Research Director, and Research/Data Assistant.

According to another aspect of the present invention, a method for conducting participatory action research in an organization includes identifying a target population within the organization, establishing a community science team comprising elite experts who have experience with the target population, collaborating with the community science team to develop research products for a study, providing the community science team with context and translation at all information touch-points, conducting the study using the research products to gather data about the target population, and using the data to inform changes in organizational practices. The elite experts may have experience in the same professional roles as the target population. The research products for the study may be developed through a series of events including workshops, systematic review of evidence-based research, independent study and participatory research, development of relevant research questions, and an After-Action Review. The data about the target population may be gathered using both qualitative and quantitative data collection methods. The community science team may comprise a Principal Investigator, Program Manager, Research Director, and Research/Data Assistant. The data may be used to inform changes in organizational practices that are specifically tailored to the target population's professional roles and experiences.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a diagram showing research within the framework of the blended community science method according to the present invention;

FIG. 2 shows a flow chart of blended community science method according to the present invention;

FIG. 3 is a table of five models of public participation in scientific research; and

FIG. 4 shows a flowchart of a method for using the blended model according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term “participatory action research” is also referred to as “PAR” in this application. Participatory action research (PAR) is an approach to research in communities that emphasizes participation and action. The communities pursue understanding of the world by trying to change the world, collaboratively and following reflection. PAR emphasizes collective inquiry and experimentation grounded in experience and social history. Within a PAR process, communities of inquiry and action evolve and address questions and issues that are significant for those who participate as co-researchers. PAR practitioners integrate participation, action, and research.

The term “subject matter expert(s)” is also referred to as “SME” in this application. Subject matter experts, or SMEs, are authorities in their field who can provide expertise to fill knowledge gaps on a project or within a company. SMEs have a deep understanding of their chosen field.

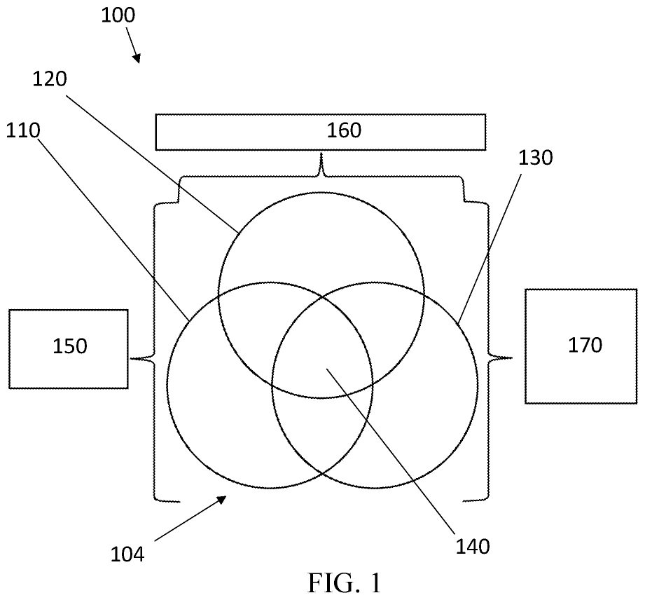

Referring now to the drawings FIGS. 1-4, and more particularly to FIG. 1, there is shown research within the framework of the blended community science method 100 has three components. The diagram depicts the contributions of each of the members of the community within the study. This blended model 104 is a progressive depiction of the method. Much like a 3-pronged trident, the applied research community 120, Community Science/PAR 130, and the population being studied 110 within the blended method complement one another. However, none can be effective alone. Within the overlap 140 of the spheres lies the nexus of usable information from which researchers can then examine as data. The overlap 140 includes the usable information available within the applied research community 120, the Community Science/PAR 130, and the population being studied 110. The specific functions of each element of the blended methodology are as follows:
Applied Researchers. This team of scientists identifies problems and determines the required outcome of the studies. They develop theories and design methods to produce new and impactful behavioral and social science techniques and practices. The applied research team communicates the necessary details to the Community Science TeamP2 (co-creators), who then arrange with the Elite ExpertsP3 (collaborators) to act as surrogates for the target population. The applied researchers then create the method of data collection using the questions provided by the Elite Expert team. The Applied Research Team submits any necessary requests for Institutional Review Board or approval for human use studies.
Community Science Team and Elite Experts. The core team consists of the Principal Investigator, Program Manager, Research Director, and Research/Data Assistant who are also elite experts. The Community Science Team core team functions include the following:
   Collaborates with the applied researchers to develop research products for the study.
   Provides the applied researchers with context and translation at all information touchpoints.
   Participates and/or coordinates workshops, steering and governance committees, surveys, and other approved quantitative and qualitative data collection methods.
   Inspects and reviews research products for quality and best fit.
   Recruits and retains operational unit champions, key positional employees, advocates, and sponsors to reduce the research-practitioner gap.
   Selects and validates the SME (also elite experts) pool to perform as surrogates for each study.
   Builds work plans and creates strategies for Community Science/PAR project success.
   Provides metrics relating to the research, including record keeping, reports, studies, articles, and white papers.
   Oversees the operations of the Community Science research team including the SMEs.

The method 100 effectively communicates with the target population being studied and their stakeholders as participants 150.

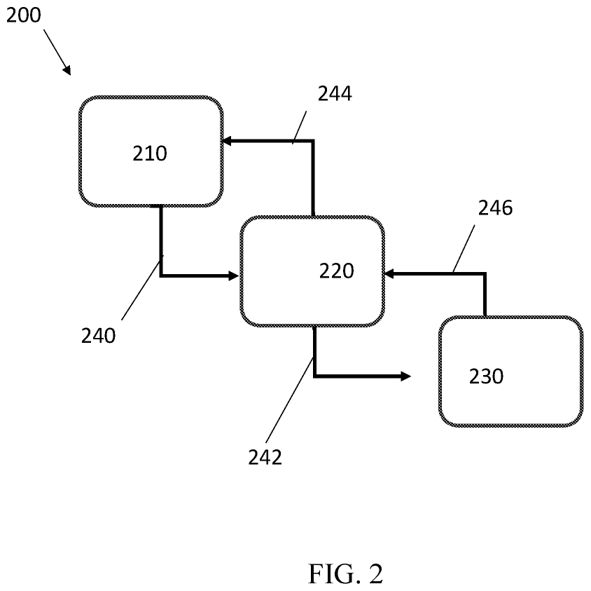

Referring to FIG. 2, there is shown a flow chart of blended community science method 200. The flowchart includes access to participants 210, Evaluation by elite experts 130 and Collaboration with elite experts as surrogates 230. Data transfer 240, 242 flows from the participants to the elite experts for evaluation and collaboration with the elite experts as surrogates. Translation 246, 244 occurs from the elite experts to the participants and for collaboration as experts. The community science team assists the applied researchers by providing context for the matter to be studied. Additionally, the core team provides translation for the questions and the eventual information gathered during the conduct of the study with the participants (target population). The core team uses a blended approach utilizing a series of events such as workshops assisting the SMEs with their portion of the project. The SME events include the following:
Homework-systematic review of evidence-based research.
Pre-work workshop-independent study and participatory research.
Preparatory Phase-development of relevant research questions.
Post-phase-After Action Review is conducted of the three preceding phases to evaluate the process and outcome to ensure the aims of the applied researchers have been met as well as recommendations for future performance.

The phases are very important as they are the elements that give validity to the process which allows for the SMEs to write the questions as surrogates for the group to be studied. PPSR projects and studies are collaborative ventures where the research community employs the constituents of the community being studied to gain greater insight as part of the project. The community science elite experts team is a group of experienced individuals who have walked a mile in the shoes of the target population to be studied. The SMEs stand in as surrogates for the practitioners of the target population. Subject matter experts often know the answer to the question, “how did we get here?” This can be an important element for the population being studied in helping them understand future directions in view of the past.

These and other objects, features, and advantages of the present invention will become more readily apparent from the attached drawings and the detailed description of the preferred embodiments, which follow.

The method of the present invention closes the research-practice gap by effectively communicating with the target population being studied and their stakeholders as participants. Advocated is the need for the community to willingly take part in research that would eventually pave the way for more relevant leader and career developmental resources. Equally important was our ability to assist the applied researchers by providing context and translation of the language of the target population.

This type of arrangement is not exclusive to the military. It is also not the traditional binary type of research found in science. The hybrid approach is a form of Community Science which is sometimes alternatively referred to as Public Participation in Scientific Research (PPSR) in which the subjects involved in an issue being studied are actively engaged in the process of the analysis. Also employed is Participatory Action Research (PAR). There are a variety of contexts for Community Science. In short, Community Science brings together practitioners and researchers. What makes the Enlisted Leader Research Group methodology so effective in narrowing the gap between the practitioners and the researchers is the blended approach described herein.

The core staff of the organization consists of former military leaders with a vast quantity of leadership experience at all echelons across the spectrum of the Army enterprise, including the most strategic levels. The company leadership diligently facilitates the selection and recruitment of uniquely qualified subject matter experts (SME) who are elite experts in their respective fields. They then act as surrogates for the population to be studied. The elite experts provide validation and context of the research allowing for the actual study phase to minimize the impediment on the practitioners'time. The importance of SMEs requires a greater depth of understanding of the differences between Applied Research and Community Science, and how the latter offers an alternative to mainstream scientific methods. Project outcomes are reflective of the degree and quality of participation by those affected by the research.

Participatory Action Research (PAR) dates back to the mid-1940s (Breitbart3) where researchers desired a greater amount of dialogue between themselves, and the community being studied. The goal wasn't to create distance between PAR and mainstream science. In fact, at times, the quantitative and qualitative methodologies are one and the same. Rather, PAR advocates the use of the community being studied to help write questions and provide input regarding the research plan. It is posited that PAR is a collaborative, iterative endeavor which places a high value on the expertise and experiences of those within the community of interest that is the focus of a particular study. One of the challenges of conducting a study of enlisted leaders is availability and willingness of participants. Because the enlisted leadership practitioners in the Army are often task-saturated by the exigencies of getting ready for the next battle or war, they simply don't have the time to participate in the design process and the study itself.

It is well-known that research ethics require extra care when conducting behavioral research with populations that may feel they do not have the ability to withhold consent to participation in a study. Research involving military personnel and employees has many of the same potential pitfalls as research involving prisoners or minors. What makes the blended community science method uniquely effective is the employment of a combination of three distinct methods by conducting experiments using our core team of elite experts (co-creators and collaborators) which, according to Norman1, the elite experts assist the applied researchers with translating their proposed study into the language of the practitioners on the front end. During the study and on the back end, they provide the applied researchers with translation and context which creates a synergistic effect among the participants. This bi-directional communication is especially important during the fieldwork and interviews. The SMEs (collaboration) also pair their knowledge and experience as surrogates to represent the practitioner population (contributors) being studied, in this case, active military enlisted leaders. The surrogates understand the challenges faced by the desired participants of the studies. In short, they have walked more than a mile in the shoes of the practitioners. In the blended community science model, the model works with the sponsors of public research to create experiments and develop techniques that will be employed in current or future research. By lessening the burden on the leadership practitioners, participation in studies is less cumbersome and takes a smaller bite out of the limited amount of time that the participants have. With greater participation comes greater effect sizes and therefore, more usable data.

Blended community science methods have the capacity to intersect with PAR and community science which enhances the researchers'abilities to address complex issues using qualitative and quantitative analysis methods. It can be stated that there is an overlap between applied research, community science and PAR (FIG. 1). Within the overlap of the spheres lies the nexus of usable information from which researchers can then examine as data (FIG. 1).

The blended community science team studies are focused on mid-level and senior-level supervisors. The daily business of the employees from the lowest tactical levels to the strategic levels is progressive with each echelon bringing new and diverse experiences and challenges. The core missions of the mid-level supervisors include accomplishing the mission and taking care of the training and welfare of their employees. The mid-level supervisors must also focus on the bottom line. Involvement in research and studies, unless specifically directed, is generally seen as an unwelcome competitor of the supervisor's time. The ethical tenets of research include the requirement that participation be explicitly voluntary. Therefore, the use of the surrogates to develop the questions takes one of the burdens off the shoulders of the participants. The community science team elite experts possess the credentials to effectively communicate with the leadership of the population being studied. This enables the desired participants to better understand the value of their contribution, which is the essence of participatory action research. Participants then engage in the studies as they see them as possibilities to improve their developmental opportunities.

The blended PAR methodology previously described can also be effectively applied to non-military, governmental, or civilian industrial/commercial populations. The civilian process is similar to the military application with a few differences. Whereas participation in research may be viewed as disruptive for military personnel, in the civilian setting time away from the office, assembly line, or the computer terminal may negatively affect the company's bottom line. Therefore, the use of qualified surrogates to create questions becomes very advantageous. The core team may, however, find challenges when searching for the necessary volume of subject matter experts to act as surrogates in purely civilian applications. Despite the challenges, the hybrid PAR method offers an economical way to involve the population being studied in the research and potentially the change process.

### Blended Community Science Method Metrics

A list of questions is prepared for research teams to use as an exemplar for metrics when conducting studies using the blended community science method. The question may include, but are not limited to:
Engagements (number of engagements, number of follow-on visits, different or repeated)?
Feedback sessions conducted?
Accepted to participate in the data collections?
Amount of feedback incorporated into ongoing research?
Overall, did the researcher make explicit in the account the theoretical framework and methods used at every stage of the research?
Was the context clearly described?
Did the elite experts provide bi-directional translation during all aspects of the study?
Was the sampling strategy theoretically comprehensive to ensure the generalizability of the conceptual analyses (diverse range of individuals and settings, for example)?
How was the fieldwork undertaken? Was it described in sufficient detail?
Could the evidence (fieldwork notes, interview transcripts, recordings, documentary analysis, etc.) be inspected independently by others; if relevant, could the process of transcription be inspected?
Were the procedures for data analysis clearly described and theoretically justified? Did they relate to the original research questions? How were the themes and concepts identified from the data?
Was the analysis repeated by more than one researcher to ensure reliability?
Did the investigator make use of quantitative evidence to ensure reliability?
Did the investigator give evidence of seeking out observations that might have contradicted or modified the analysis?
Was a sufficient amount of the original evidence presented systematically in the written account to satisfy the skeptical reader of the relation between the interpretation and the evidence (for example, were quotations numbered and sources given)?

The measure of the contribution or effectiveness of the blended community science method participation for each of the functions and subtasks should include an objective examination of the subtasks for that research event. The general purpose of collaborative studies, such as those conducted by the community science teams, is not regression analysis. Linear regressions are best suited for evaluating variables for the purpose of examining relationships and predicting future performance or outcomes. The empirical nature desired of scientific research implies that research design and methods carried out correctly are reproduceable by others seeking to conduct similar studies.

Reproducibility traditionally is not an expectation with PAR studies since they are not randomized studies. However, with this novel blended model, the methodology may be reproduced, and comparable results should be expected. Another limitation of PAR studies is the possibility of co-option. Co-option is a situation where the studies are conducted in collaboration with powerful institutions. The participants may experience real or perceived social pressures to be inclusive or otherwise diverse to serve the interests of another group. The blended methodology reduces the likelihood of co-option due to the bi-lateral communication of the elite experts with the participants and the sponsors of studies using community science.

Change management studies, especially PAR studies, are driven towards outputs and outcomes. Outputs are the initial data related to the study. These data can be observations recorded and reported as data. The applied researchers will gather and determine how the data will be used. The core team provides context and translation of the information, as required. The decision of how to use the information will often be determined by the reason for the study. The outcomes of blended community science method are measurable components such as behaviors, skills, knowledge, and abilities that are related to the outputs of the research.

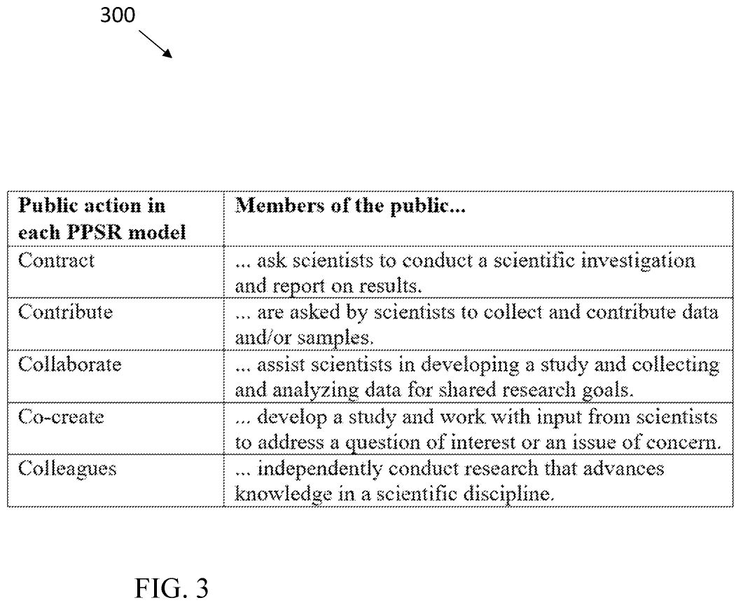

Referring to FIG. 3, the table 300 shows how the five models of public participation in scientific research (PPSR) projects are divided. The actions are contractual, contributory, collaborative, co-created, and collegial. The actions are based on the extent of practitioner participation. The blended community science model simultaneously employs three of the models, the collaborative, contributed, and co-created, thereby creating a uniquely symbiotic technique.

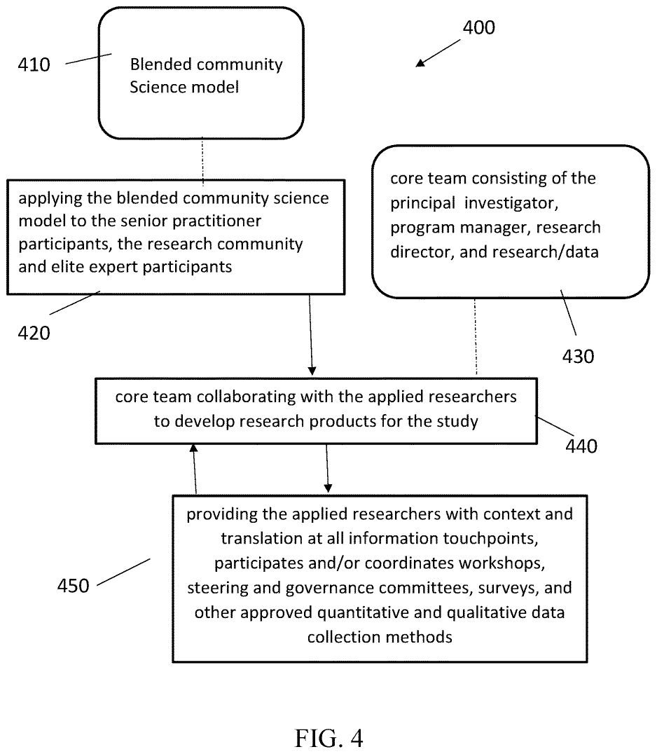

FIG. 4 shows a flowchart of a method 400 for using the blended model 410. The blended community science model includes senior practitioner participants, a research community, and elite expert participants. The method 400 includes applying 420 the blended community science model 410 to the senior practitioner participants, the research community and elite expert participants. The blended community science model includes a core team 430 consisting of the principal investigator, program manager, research director, and research/data assistant who are also elite experts. The core team collaborates 440 with the applied researchers to develop research products for the study. The core team provides 450 the applied researchers with context and translation at all information touchpoints, participates and/or coordinates workshops, steering and governance committees, surveys, and other approved quantitative and qualitative data collection methods, allowing more core team collaborating with the applied researchers to develop research products for the study. The cycle repeats for continued improvement of the model and the participants.

The present disclosure pertains to the field of organizational development, specifically focusing on innovative research methodologies aimed at enhancing the effectiveness of personnel development within an organization. In some aspects, the disclosure introduces a blended approach that combines elements of community science and participatory action research, aiming to bridge the gap between researchers and practitioners in the organization. This approach may involve the active participation of elite experts who have extensive experience with the target population within the organization, thereby providing valuable insights and context to the research.

In some cases, the target population within the organization may comprise mid-level and senior-level supervisors. The elite experts, who may have experience in the same professional roles as the target population, collaborate with the research team to develop research products for a study. These research products may be developed through a series of events including workshops, systematic review of evidence-based research, independent study and participatory research, and development of relevant research questions.

The research products are then used to conduct the study and gather data about the target population. The data collection may employ both qualitative and quantitative methods, providing a comprehensive understanding of the target population's experiences, perspectives, and challenges. The gathered data may then be used to inform changes in organizational practices, potentially leading to improved personnel development and overall organizational effectiveness.

In some respects, the community science team may comprise a Principal Investigator, Program Manager, Research Director, and Research/Data Assistant. This team plays a pivotal role in providing context and translation at all information touchpoints, thereby ensuring that the research is relevant and understandable to the target population. This approach may result in increased participation in the study, leading to more robust and reliable data.

The method for enhancing organizational development begins with identifying a target population within an organization. The target population may comprise individuals who hold specific roles within the organization. For instance, in some cases, the target population may comprise mid-level and senior-level supervisors. These individuals often play a pivotal role in the organization, overseeing the work of other employees, making strategic decisions, and contributing to the overall success of the organization. Therefore, understanding their experiences, perspectives, and challenges can provide valuable insights for enhancing organizational development.

Once the target population is identified, a community science team may be established. The community science team may comprise elite experts who have extensive experience with the target population. In some cases, these elite experts may have experience in the same professional roles as the target population. For example, if the target population comprises mid-level and senior-level supervisors, the elite experts may be individuals who have previously held or currently hold similar supervisory roles within the organization or in similar organizations. This shared experience allows the elite experts to understand the context and nuances of the target population's roles, thereby enhancing the relevance and applicability of the research.

The community science team, including the elite experts, may then collaborate to develop research products for a study. These research products may include, but are not limited to, research questions, data collection instruments, and data analysis plans. The development of these research products may involve a series of events, such as workshops, systematic review of evidence-based research, independent study and participatory research, and development of relevant research questions. These events allow the community science team and the elite experts to leverage their collective expertise and insights, resulting in research products that are tailored to the specific context and challenges of the target population.

In addition to developing the research products, the community science team may also provide context and translation at all information touchpoints. This may involve explaining the purpose and relevance of the research to the target population, translating technical research terms into language that the target population can understand, and providing context for the research findings. This approach ensures that the research is not just about the target population, but also for the target population, thereby enhancing the relevance and impact of the research.

The study may be conducted using the research products to gather data about the target population. The data collection may employ both qualitative and quantitative methods, providing a comprehensive understanding of the target population's experiences, perspectives, and challenges. The gathered data may then be used to inform changes in organizational practices, potentially leading to improved personnel development and overall organizational effectiveness.

In some aspects, the process of enhancing organizational development begins with the identification of a target population within an organization. The target population may be defined based on specific roles or positions within the organization. For instance, in some cases, the target population may comprise mid-level and senior-level supervisors. These individuals often play a pivotal role in the organization, overseeing the work of other employees, making strategic decisions, and contributing to the overall success of the organization. Therefore, understanding their experiences, perspectives, and challenges can provide valuable insights for enhancing organizational development.

Once the target population is identified, a community science team may be established. This team may comprise elite experts who have extensive experience with the target population. In some cases, these elite experts may have experience in the same professional roles as the target population. For example, if the target population comprises mid-level and senior-level supervisors, the elite experts may be individuals who have previously held or currently hold similar supervisory roles within the organization or in similar organizations. This shared experience allows the elite experts to understand the context and nuances of the target population's roles, thereby enhancing the relevance and applicability of the research.

The community science team, including the elite experts, may then collaborate to develop research products for a study. These research products may include, but are not limited to, research questions, data collection instruments, and data analysis plans. The development of these research products may involve a series of events, such as workshops, systematic review of evidence-based research, independent study and participatory research, and development of relevant research questions. These events allow the community science team and the elite experts to leverage their collective expertise and insights, resulting in research products that are tailored to the specific context and challenges of the target population.

In addition to developing the research products, the community science team may also provide context and translation at all information touchpoints. This may involve explaining the purpose and relevance of the research to the target population, translating technical research terms into language that the target population can understand, and providing context for the research findings. This approach ensures that the research is not just about the target population, but also for the target population, thereby enhancing the relevance and impact of the research.

The study may be conducted using the research products to gather data about the target population. The data collection may employ both qualitative and quantitative methods, providing a comprehensive understanding of the target population's experiences, perspectives, and challenges. The gathered data may then be used to inform changes in organizational practices, potentially leading to improved personnel development and overall organizational effectiveness. The establishment of a community science team may be a pivotal step in the method for enhancing organizational development. The community science team may comprise elite experts who have extensive experience with the target population. These elite experts may have held similar roles or positions within the organization or in similar organizations, providing them with a deep understanding of the experiences, perspectives, and challenges of the target population. This shared experience may enhance the relevance and applicability of the research, as the elite experts can provide valuable insights and context that may not be accessible through traditional research methods. The community science team may also play a role in reducing the research-practice gap by recruiting and retaining operational unit champions, advocates, and sponsors. These individuals may serve as liaisons between the research team and the target population, facilitating communication and collaboration. By fostering a sense of ownership and involvement in the research process, these champions, advocates, and sponsors may help to increase the participation of the target population in the study, thereby enhancing the robustness and reliability of the data.

In some aspects, the community science team may comprise a Principal Investigator, Program Manager, Research Director, and Research/Data Assistant. The Principal Investigator may oversee the overall direction and integrity of the research, while the Program Manager may coordinate the various activities and resources involved in the research. The Research Director may be responsible for the design and implementation of the research methodology, and the Research/Data Assistant may assist in data collection, analysis, and reporting. This team structure may ensure that the research is conducted in a systematic, rigorous, and ethical manner. In some cases, the community science team may also provide context and translation at all information touchpoints. This may involve explaining the purpose and relevance of the research to the target population, translating technical research terms into language that the target population can understand, and providing context for the research findings. This approach may ensure that the research is not just about the target population, but also for the target population, thereby enhancing the relevance and impact of the research.

In some aspects, the collaboration with the community science team to develop research products for a study may be a central part of the method for enhancing organizational development. The research products may include, but are not limited to, research questions, data collection instruments, and data analysis plans. These products may be designed to gather comprehensive and relevant data about the target population, thereby providing valuable insights for enhancing organizational development. The development of these research products may involve a series of events. For instance, in some cases, the process may begin with workshops where the community science team and the elite experts come together to brainstorm, discuss, and refine the research questions and methods. These workshops may provide a platform for the exchange of ideas and insights, fostering a collaborative and inclusive research environment. Following the workshops, a systematic review of evidence-based research may be conducted. This review may involve a thorough examination of existing literature and studies related to the target population and their roles within the organization. The findings from this review may inform the development of the research questions and methods, ensuring that they are grounded in empirical evidence and current knowledge.

In some cases, independent study and participatory research may also be part of the process. The elite experts may engage in independent study to deepen their understanding of the target population and their experiences, perspectives, and challenges. They may also participate in the research process, providing valuable insights and context that can enhance the relevance and applicability of the research. The development of relevant research questions may be another integral part of the process. These questions may be designed to probe the experiences, perspectives, and challenges of the target population, thereby providing valuable data for enhancing organizational development. The elite experts may play a pivotal role in this process, leveraging their experience and insights to formulate questions that are relevant and meaningful to the target population. An after-action review may be conducted at the end of the process. The After-Action Review may involve a thorough evaluation of the process and its outcomes, identifying areas of success and areas for improvement. The findings from this review may inform future research efforts, contributing to the continuous improvement of the method for enhancing organizational development.

The collaboration with the community science team to develop research products for a study may be a central part of the method for enhancing organizational development. This collaborative approach, involving a series of events such as workshops, systematic review of evidence-based research, independent study and participatory research, development of relevant research questions, and an After-Action Review, may result in research products that are tailored to the specific context and challenges of the target population, thereby enhancing the relevance and impact of the research.

The community science team, which may include elite experts, plays a pivotal role in providing context and translation at all information touchpoints throughout the research process. This may involve explaining the purpose and relevance of the research to the target population, translating technical research terms into language that the target population can understand, and providing context for the research findings. This approach ensures that the research is not just about the target population, but also for the target population, thereby enhancing the relevance and impact of the research.

The elite experts on the community science team may have experience in the same professional roles as the target population. For example, if the target population comprises mid-level and senior-level supervisors, the elite experts may be individuals who have previously held or currently hold similar supervisory roles within the organization or in similar organizations. This shared experience allows the elite experts to understand the context and nuances of the target population's roles, thereby enhancing the relevance and applicability of the research. The elite experts may leverage their experience and insights to provide context and translation at all information touchpoints. For instance, they may help translate technical research terms into language that the target population can understand, thereby facilitating better communication and understanding between the researchers and the target population. They may also provide context for the research findings, helping the researchers and the target population understand the implications and potential applications of the research. The elite experts may also assist in the development of research products for the study. These research products may include, but are not limited to, research questions, data collection instruments, and data analysis plans. The elite experts may leverage their experience and insights to help formulate research questions that are relevant and meaningful to the target population. They may also assist in the design of data collection instruments that are tailored to the specific context and challenges of the target population. Furthermore, they may contribute to the development of data analysis plans that take into account the nuances and complexities of the target population's experiences, perspectives, and challenges.

The community science team, including the elite experts, plays a pivotal role in providing context and translation at all information touchpoints, thereby enhancing the relevance and impact of the research. The elite experts, with their experience in the same professional roles as the target population, provide valuable insights and context that enhance the relevance and applicability of the research. Their involvement in the development of research products ensures that these products are tailored to the specific context and challenges of the target population, thereby enhancing the effectiveness of the method for enhancing organizational development.

In some aspects, the study may be conducted using the research products developed by the community science team to gather data about the target population. This data collection process may employ both qualitative and quantitative methods, providing a comprehensive understanding of the target population's experiences, perspectives, and challenges.

Qualitative data collection methods may include, but are not limited to, interviews, focus groups, and observations. These methods may allow for an in-depth exploration of the target population's experiences and perspectives, providing rich and detailed data. For instance, interviews and focus groups may be conducted with members of the target population to gain insights into their experiences, perspectives, and challenges in their roles within the organization. Observations may also be conducted to gain a firsthand understanding of the target population's behaviors, interactions, and practices within the organizational context. Other quantitative data collection methods may include surveys, questionnaires, and statistical analysis. These methods may allow for the collection of numerical data that can be analyzed to identify patterns, trends, and relationships. For instance, surveys and questionnaires may be administered to the target population to gather data on various aspects of their roles within the organization, such as their job satisfaction, performance, and professional development. Statistical analysis may then be conducted on this data to identify patterns and trends, and to measure variables within the target population. The data gathered through these qualitative and quantitative methods may provide a comprehensive understanding of the target population's experiences, perspectives, and challenges. This data may then be used to inform changes in organizational practices, potentially leading to improved personnel development and overall organizational effectiveness. The use of both qualitative and quantitative data collection methods may ensure that the research is robust and comprehensive, capturing the complexity and nuances of the target population's experiences and perspectives.

In some aspects, the gathered data from the study may be used to inform changes in organizational practices. These changes may be specifically tailored to the target population's professional roles and experiences, thereby enhancing the effectiveness of personnel development within the organization. For instance, if the data reveals that mid-level supervisors within the organization are facing challenges in managing their teams due to a lack of leadership training, the organization may implement new leadership development programs or modify existing ones to address these challenges. Similarly, if the data indicates that senior-level supervisors are struggling with strategic decision-making due to a lack of relevant information or resources, the organization may take steps to improve information sharing and resource allocation at the senior level. The community science team may play a role in recruiting and retaining operational unit champions, advocates, and sponsors to reduce the research-practice gap. These individuals may serve as liaisons between the research team and the target population, facilitating communication and collaboration. By fostering a sense of ownership and involvement in the research process, these champions, advocates, and sponsors may help to increase the participation of the target population in the study, thereby enhancing the robustness and reliability of the data.

The research products for the study may be developed through a series of events. These events may include workshops, systematic review of evidence-based research, independent study and participatory research, and development of relevant research questions. Each of these events may contribute to the development of research products that are tailored to the specific context and challenges of the target population. For instance, workshops may provide a platform for the community science team and the elite experts to brainstorm, discuss, and refine the research questions and methods. Systematic review of evidence-based research may inform the development of the research questions and methods, ensuring that they are grounded in empirical evidence and current knowledge. Independent study and participatory research may allow the elite experts to deepen their understanding of the target population and their experiences, perspectives, and challenges. The development of relevant research questions may involve the formulation of questions that are relevant and meaningful to the target population, thereby providing valuable data for enhancing organizational development.

The data gathered from the study may be used to inform changes in organizational practices that are specifically tailored to the target population's professional roles and experiences. For instance, if the data reveals that mid-level supervisors within the organization are facing challenges in managing their teams due to a lack of leadership training, the organization may implement new leadership development programs or modify existing ones to address these challenges. Similarly, if the data indicates that senior-level supervisors are struggling with strategic decision-making due to a lack of relevant information or resources, the organization may take steps to improve information sharing and resource allocation at the senior level. These changes in organizational practices, informed by the data gathered from the study, may lead to improved personnel development and overall organizational effectiveness.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for conducting personnel development studies, the method comprising:
providing a blended community science model including:
senior practitioner participants;
elite expert participants;
a research community;
a first team of applied researchers for identifying problems and determine the outcome of the studies; and
a core team including a community science team and elite experts;
applying the blended community science model to the senior practitioner participants, the research community and elite expert participants;
wherein the first team communicates the details to the community science team wherein the community science team arranges with the elite experts to act as surrogates for a target population;
wherein the applied researchers create a method of data collection using questions provided by the elite experts; and
wherein the elite experts communicate with the participants, which provides them with a better understanding of the nature of the study.

2. The method of claim 1, wherein the applied researchers submit requests for an institutional review board or approval for human use studies.

3. The method of claim 1, wherein the core team consists of the principal investigator, program manager, research director, and research/data assistant who are also elite experts.

4. The method of claim 3, wherein the core team collaborates with the applied researchers to develop research products for the study.

5. The method of claim 4, wherein the core team provides the applied researchers with context and translation at all information touchpoints and wherein the core team participates and/or coordinates workshops, steering and governance committees, surveys, and other approved quantitative and qualitative data collection methods.

6. The method of claim 5, wherein the core team inspects and reviews research products for quality and the core team recruits and retains operational unit champions, advocates, and sponsors to reduce the research-practitioner gap.

7. A method for conducting personnel development studies, comprising:
providing a blended community science model including senior practitioner participants, a research community, and elite expert participants;
applying the blended community science model to the senior practitioner participants, the research community and elite expert participants;
wherein the blended community science model includes a core team consisting of the principal investigator, program manager, research director, and research/data assistant who are also elite experts;
wherein the core team collaborates with the applied researchers to develop research products for the study, provides the applied researchers with context and translation at all information touchpoints, participates and/or coordinates workshops, steering and governance committees, surveys, and other approved quantitative and qualitative data collection methods.

8. The method of claim 7, wherein the core team inspects and reviews research products for quality and the core team recruits and retains operational unit champions, advocates, and sponsors to reduce the research-practitioner gap.

9. The method of claim 8, wherein the core team selects and validates an SME or elite expert pool to perform as surrogates for each study.

10. The method of claim 9, wherein the core team builds work plans and creates strategies for Community Science/PAR project success.

11. The method of claim 10, wherein the core team provides metrics relating to the research, including record keeping, reports, studies, articles, and white papers.

12. The method of claim 11, wherein the core team oversees the operations of the Community Science research team including the SMEs.

13. The method of claim 12, including SME events having a systematic review of evidence-based research, an independent study and participatory research, development of relevant research questions, and an after-action review of the three preceding phases to evaluate the process and outcome to ensure the aims of the applied researchers have been met as well as recommendations for future performance.

14. A method for enhancing organizational development, comprising:
identifying a target population within an organization;
establishing a community science team comprising elite experts who have experience with the target population;
collaborating with the community science team to develop research products for a study;
providing the community science team with context and translation of information for the study; and
conducting the study using the research products to gather data about the target population.

15. The method of claim 14, wherein the target population within the organization comprises mid-level and senior-level supervisors.

16. The method of claim 15, wherein the elite experts have experience in the same professional roles as the target population.

17. The method of claim 16, further comprising the step of recruiting and retaining operational unit champions, advocates, and sponsors to reduce the research-practice gap.

18. The method of claim 17, wherein the research products for the study are developed through a series of events including workshops, systematic review of evidence-based research, independent study and participatory research, development of relevant research questions, and an After-Action Review.

19. The method of claim 14, wherein the data about the target population is gathered using both qualitative and quantitative data collection methods.

20. The method of claim 14, wherein the community science team comprises a Principal Investigator, Program Manager, Research Director, and Research/Data Assistant.
